(19) United States
(12) Patent Application Publication
(10) Pub. No.: US 2013/0110947 A1
(43) Pub. Date: May 2, 2013

(54) Systems and Methods of Providing Personalized Alerts

(71) Applicants: Michael Boukadakis, Austin, TX (US); Sai Ganesh, Austin, TX (US); Matthew R. Merritt, Austin, TX (US)

(72) Inventors: Michael Boukadakis, Austin, TX (US); Sai Ganesh, Austin, TX (US); Matthew R. Merritt, Austin, TX (US)

(21) Appl. No.: 13/657,532

(22) Filed: Oct. 22, 2012

Related U.S. Application Data
(60) Provisional application No. 61/552,161, filed on Oct. 27, 2011.

(51) Int. Cl. G06F 15/16

(52) U.S. Cl. 709/206

(57) ABSTRACT

A computer-readable storage medium embodies instructions that, when executed by a processor, cause the processor to receive media content from one or more sources, where the media content including a first portion that is personalized for a user by a selected persona of a plurality of personas. The computer-readable storage medium further embodies instructions that, when executed, cause the processor to store the media content in a memory and send the media content as an electronic alert to a user device according to a user-defined schedule.

### CROSS REFERENCE TO RELATED APPLICATION(S)

This application is a non-provisional of and claims priority to U.S. Provisional Patent Application No. 61/552,161 filed on Oct. 27, 2011 and entitled “System and Methods for Providing Audio Alerts,” which is incorporated herein by reference in its entirety.

### FIELD

This disclosure relates generally to scheduling systems, and more particularly to scheduling systems that allow a subscriber to schedule delivery of an alert related to an event.

### BACKGROUND

Generally, calendar software is available that allows a user to schedule an alert (or reminder) associated with an event, such as a meeting. Such software permits the user to schedule transmission of a reminder at a scheduled time prior to the event. Web-based calendar software, such as Google Calendar and Hotmail Calendar often send the reminder in the form of an email or text message.

Further, some subscriber systems, such as Twitter®, permit a subscriber to subscribe to broadcast messages from other subscribers. Such broadcasts (or “Tweets”) are typically multicast text messages that are broadcast to multiple subscribers (or followers) simultaneously. However, the user does not control the timing of the receipt of such messages.

### SUMMARY

In an embodiment, a computer-readable storage medium embodies instructions that, when executed by a processor, cause the processor to receive media content from one or more sources, where the media content including a first portion that is personalized for a user by a selected persona of a plurality of personas. The computer-readable storage medium further embodies instructions that, when executed, cause the processor to store the media content in a memory and send the media content as an electronic alert to a user device.

In another embodiment, a system includes an interface configurable to couple to a network, a processor coupled to the interface, and a memory accessible to the processor. The memory is configured to store instructions that, when executed by the processor, cause the processor to assemble media content including a first portion customized for a subscriber by a selected persona of a plurality of personas. The memory further includes instructions that, when executed, cause the processor to determine a scheduled event associated with the subscriber and transmit the media content through the network to a device associated with the subscriber according to the scheduled event.

In still another embodiment, a method includes receiving a first media content customized for a subscriber by a selected persona of a plurality of personas, selecting an advertisement from a plurality of advertisements according to a plurality of selection rules, and combining the first media and the advertisement to produce media content. The method further comprises transmitting the media content to a subscriber device through a network according to a predetermined schedule.

### BRIEF DESCRIPTION OF THE DRAWINGS

FIG. 1 is a block diagram of a system including a server system for providing alerts.

FIG. 2 is a conceptual block diagram of a system including a server system for providing alerts using a plurality of distributed systems and data sources.

FIG. 3 depicts one possible embodiment of a “Campaigns” tab of a graphical user interface for a Broadcasting System of the server system of FIG. 1.

FIG. 4 is an exemplary diagram of one possible embodiment of a “Functional Administrators” tab of a graphical user interface for a Broadcasting System of the server system of FIG. 1.

FIG. 5 is an exemplary diagram of one possible embodiment of a “Personalities” tab of a graphical user interface for a Broadcasting System of the server system of FIG. 1.

FIG. 6 is an exemplary diagram of one possible embodiment of a “Configure Roles” tab of a graphical user interface for a Broadcasting System of the server system of FIG. 1.

FIG. 7 is an exemplary diagram of one possible embodiment of a “Manage Streams” tab of a graphical user interface for a Broadcasting System of the server system of FIG. 1.

FIG. 8 is a flow diagram of an embodiment of a method of receiving data related to an advertising campaign for inclusion within an alert.

FIG. 9 is a flow diagram of an embodiment of a method of providing alerts to a subscriber device according to a user-defined schedule.

FIG. 10 is a flow diagram of an embodiment of a method of selecting an advertisement for inclusion within an alert.

FIG. 11 is an exemplary diagram of one possible embodiment of a graphical user interface for creating a new subscriber account.

FIG. 12 is an exemplary diagram of one possible embodiment of a graphical user interface for allowing a subscriber to subscribe to one or more streams.

FIG. 13 is an exemplary diagram of one possible embodiment of a graphical user interface for allowing the subscriber to add and/or configure one-time and recurring alerts.

In the following discussion, the same reference numbers are used in the various embodiments to indicate the same or similar elements.

### DETAILED DESCRIPTION OF ILLUSTRATIVE EMBODIMENTS

Embodiments of a system are described below that facilitate personalized interactions between individuals. In a particular example, the system provides a social media vehicle for connecting individuals to selected personas. As used herein, the term “persona” refers to a digital or on-line presence or representation of a particular user. A user may have multiple personas, such as a work persona and a private persona. A user that is a celebrity may also have multiple personas. In the case of a comedian or voice actor, the user may have a persona for each of his/her acting roles or characters, so that other subscribers can subscribe to the particular persona of their favorite celebrities.

Further, embodiments of the system allow users to subscribe to receive alerts from selected personas and to allow users to respond to messages from those selected personas, facilitating interaction between celebrities and their fans, via personalized electronic messages and responses. As used herein, the term “personalized” refers to creation of at least a portion of the media content specifically for the particular subscriber. One possible example of such personalized media content may include an audio introduction to a voice message that states “Hello Mark! I'm calling to remind you about a birthday party at 4 pm, but before I do, listen to this offer from one of our sponsors . . . ”

In one example, a subscriber may elect to receive media content messages (including audio, video, text, static images, or any combination thereof) from a persona associated with another user, and the celebrity associated with the persona may record and send media messages, including audio, video, text, or any combination thereof to his/her subscribers. The celebrity or his/her manager may schedule a multi-cast transmission, which may be delivered at a first time determined by the sender or at a second time specified by each subscriber. In some embodiments, the celebrity may record and send personalized messages to a particular subscriber. Further, in some embodiments, subscribers may respond to the message from the sender. Thus, the system allows the users to connect with celebrity personas and to personas of other subscribers, and vice versa, providing the flexibility for the celebrity to interact with his/her subscribers.

Further, the subscriber may schedule certain alerts and select a particular persona for delivery of a media alert (such as a voice message) at a selected time. In particular, the system allows a user to configure one or more events or alarms in a calendaring system and to select one or more personas and select a media content type (audio, audio/visual, text, or any combination thereof) and the user associated with the selected persona will provide suitable media content for delivery in connection with the one or more events or alarms. For example, in one instance, a user may schedule a wakeup call at a particular time, and request a persona associated with a radio personality (who is signed up as a client) to provide media content associated therewith. The system provides an alert to the user associated with the persona with automated text to be recorded by the celebrity-client and uploaded to the system. Once the celebrity-client uploads the media content to the system, the system then converts the media content to a desired format, and provides the media content to the user at the appointed day/time. In some instances, the media content may be combined with one or more other media files (such as one or more advertisements) to produce an media content file, which can be provided to a subscriber device according to the subscriber's preferences and at a time/day scheduled by the user. In an embodiment, the user may specify the media content type (such as audio only, text only, or multi-media, including audio, video, text, or any combination thereof), in which case the uploaded media content may include or may be converted to the selected media content type and can be converted into a suitable format for transmission to the user.

In an embodiment, the system provides a subscriber interface that allows a user to configure his/her account, including scheduling one-time alerts and recurring alerts and/or subscribing to one or more available data streams associated with particular personas. The user may elect to receive the data streams as text messages, emails, audio alerts, or other types of media content via the user's cell phone or computer. In some instances, the user may configure his/her scheduled alerts to be provided by a particular persona, such as a radio personality, an athlete, a television personality, or another celebrity. In an example, a particular persona may represent a character or role played by the particular user.

In an embodiment, the system may push media content to an application executing on a user device, such as a plugin executing within an Internet browser application or an application executing on a portable communications device, such as a smart phone. In some embodiments, media content may be pushed to a text message application or other messaging application. In one example, the user may download the plugin or application to his/her user device and interact with the system to configure one or more of the alerts for transmission to the plugin or application executing on the user device.

The system also provides an advertiser interface that allows an advertising-client (such as an advertising firm, a radio station, a political campaign, or other advertising content source) to configure an advertising campaign. The advertising-client may also record or upload media content, which can be combined with media content provided by a selected persona to produce media content for transmission to subscribers.

The system further includes a client interface that allows the user to configure administrative privileges, to create roles, such as “personalities” corresponding to individuals who may have a fan following (such as a celebrity or athlete) and/or to establish “functional administrators” for managing advertising campaigns and associated audio streams. In some instances, the client interface is configurable to prompt personalities to record advertising text (for an advertising campaign) and/or personalized greetings for a subscriber (such as “Hi Bob, this is Buddy the Man. I'll be right back with an important message for you, right after this sponsor message.”). This type of personalized greeting can be combined with selected advertising content and other information (such as an advertisement and alert information) to provide media content that can be sent to a subscriber device, such as a smart phone or a computer, in the form of an electronic transmission, such as a phone call, audio recording, text message, audio/visual message, other media content, or as text including a user selectable link, which can be provided as a scheduled alert.

In an example, the alert can include an option for the subscriber to interact with the system. For example at the end of an alert sent via a cell phone call, the alert may include an option for the subscriber to select a number to take advantage of a special offer. In another example, a subscriber can reply to an email message to post a response on the subscriber's wall, which reply can be shared with other subscribers, such as on an electronic bulletin board or social media website. Such a response may be an audio response, a video response, a text response, or any combination thereof. In a particular example, the response may be posted on the subscriber's wall as well as a wall corresponding to a persona of a particular celebrity. In one particular example, the system may link to a social media website, such as Facebook®, and may automatically post the reply in a suitable format and/or a text reply with a link to the media content of the response on the subscriber's and/or the celebrity's page(s).

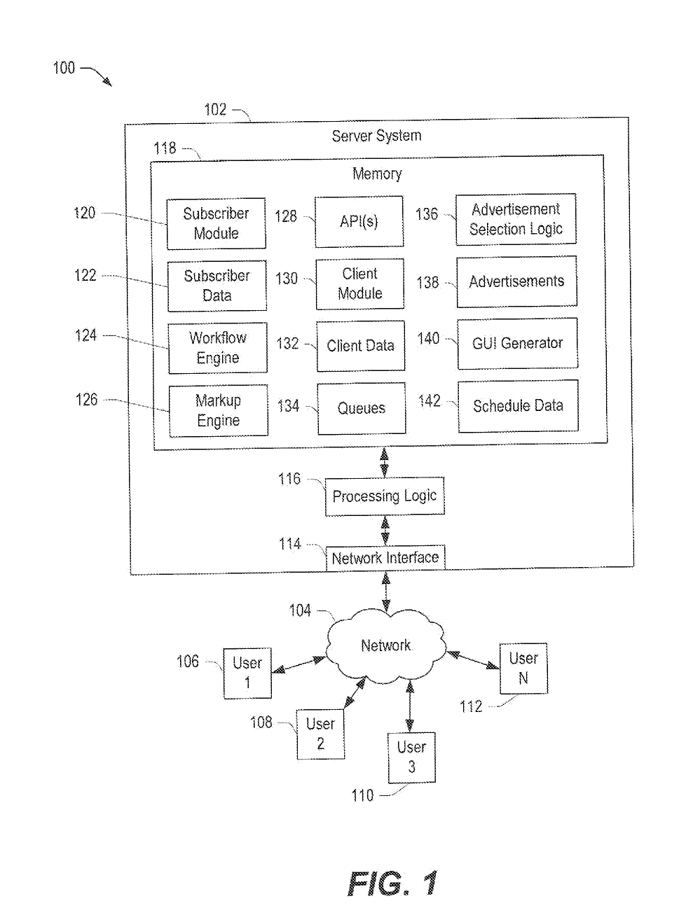

The system makes it possible to associate subscribers and “personalities” by allowing subscribers to “opt in” or elect to receive messages including media content from personas. As used herein, the term “media content” refers to audio content, video content, text content, static images, or any combination thereof. Further, the system makes it possible to place advertising content (optionally including interactive offers) within the messages, and to target the advertising content to the user's demographic information. An example of a system configured to provide such functionality is described below with respect to FIG. 1.

FIG. 1 is a block diagram of a system 100 including a server system 102 for providing alerts including media content. Server system 102 is coupled to a network 104, such as the Internet, and to one or more computing devices 106, 108, 110, and 112, such as cell phones, personal computers, personal digital assistants (PDAs), or other devices configured to execute software instructions.

Server system 102 includes a network interface 114 configurable to couple to network 104 and includes processing logic 116 coupled to network interface 114 and to memory 118. Server system 102 can be implemented as a single computer executing server software, in which case processing logic 116 can be a general purpose processor configured to execute software instructions stored in memory. In another embodiment, server system 102 can be implemented as a server farm having multiple computers with distributed memory and distributed processing. The term “processing logic” as used herein refers to either a single processor within a computer or such distributed processing across multiple servers.

In the illustrated example, memory 118 stores a plurality of instructions, including modules, generators, and engines, that are executable by processing logic 116 to perform multiple functions in conjunction with stored data. Memory 118 includes a subscriber module 120 executable by processing logic 116 to register one or more subscribers, to capture subscriber settings and preferences, to schedule events, and to subscribe to one or more data streams Memory 118 further stores such subscriber information in subscriber data 122 and in schedule data 142.

Memory 118 includes a client module 130 executable by processing logic 116 to register one or more clients, to create one or more “personalities” or “personas” associated with each client, and to upload and/or register one or more media content data streams, such as audio clips, video clips, and the like. In some instances, client module 130 causes processing logic 116 to prompt a particular user to record media content by providing the user a script and/or by providing a user selectable button that the user can select to upload media content. The client setup information and associated data streams are stored as client data 132 in memory 118.

Memory 118 further includes a workflow engine 124 executable by processing logic 116 to process the subscriber data 122 and client data 132 and to produce alerts from the media content according to schedule data included in the subscriber data 122. Memory 118 includes a markup engine (or formatter) 126 that, when executed, causes processing logic 116 to convert alerts to appropriate formats for transmission to subscribers according to format preferences recorded in the subscriber data 122 for each subscriber. Memory 118 also includes an application programming interface (API) module 128 having a set of rules (‘code’) and specifications that software programs can follow to communicate with each other. API module 128 serves as an interface between different software programs and facilitates their interaction.

Memory 118 also includes advertisement selection logic 136 configured to implement a set of rules and decision-making processes for selecting one or more advertisements from a plurality of advertisements 138 stored in memory. Such selection may be based on demographic selections made by the advertiser that correspond to the demographic of the particular subscriber. Memory 118 further includes a graphical user interface (GUI) generator 140 executable by processor 116 to produce a GUI that can be rendered within an Internet browser application, such as Microsoft® Internet Explorer® or another browser application. The GUI includes user selectable elements, such as hypertext links, buttons, tabs, pull-down menus, text boxes, check boxes, radio buttons, and other user-selectable elements allowing for user selections and data input.

In an example, server system 102 manages operations using a series of queues 134, which are updated with changes from the client or the advertiser and/or with scheduled triggers from client data 132 and/or schedule data 142. Further, subscriber module 120 allows the subscriber to specify timing of receipt of particular alerts, which may include advertising and other media content. Client module 130, subscriber module 120, and advertising selection logic 136 can modify the queues 134. Additionally, in some instances, workflow engine 124 can update the queues 134 with schedule data 142. The queues 134 may be first-in first-out (FIFO) queues that cause the workflow engine 124 to process the items in the queue in the order that they are received.

In operation, subscribers can create an account with the server system 102 by accessing selectable elements within a GUI provided by GUI generator 140 in conjunction with subscriber module 120. As part of the account setup process or after the account is setup, the subscriber can access his/her account details through a website provided by GUI generator 140 to schedule alerts and/or subscribe to one or more streams of media content and to specify how he/she would like to receive the alerts or subscribed streams (i.e., to what particular device or address and in what particular format(s)). For example, the subscriber may request a phone call audio alert to be sent to his/her cell phone or an email alert or text message including a link to a message that includes media content. In some instances, the subscriber may select an alert or subscription that includes audio, video, text, or any combination thereof. The subscriber may also schedule one or more alerts in the form of a one-time alert or a recurring alert.

Clients can create an account with the server system 102 by accessing a GUI provided by GUI generator 140 in conjunction with client module 130. Client accounts may be created and/or accessed by visiting a uniform resource locator (URL) that is different from that accessed by subscribers. A client may be a radio station, a television station, an advertising/marketing firm, a celebrity, a politician, or other entity. Once the client creates an account, the client can configure the account to define roles for individuals and to define one or more personalities or personas. The individual associated with the persona will produce media content for delivery by server system 102, such as a radio personality, a celebrity, a television star, etc. The client may also establish update preferences (such as update frequency and timing), define advertising campaigns having start/end dates, select target audiences (for example, based on demographic information, musical preferences, etc.), and so on.

Subscribers may access their accounts through a website to subscribe to media content streams from one or more personalities. Once subscribed, the subscribers receive new media content according to the preferences specified by the user, e.g., text, email, phone call, multimedia message, etc. Further, the subscriber may configure (schedule) an alert in his/her calendar as a reminder, for example, and may specify a persona for presentation of the alert. In response thereto, workflow engine 124 may trigger client module 130 to prompt the user associated with the persona to provide customized media content that can be stored for playback and/or transmission at a scheduled day and time as part of the alert sent to the subscriber. At some point in time before the scheduled event, workflow engine 124 may cause advertisement selection logic 136 to select one or more of the plurality of advertisements 138 according to a plurality of selection rules and may cause markup engine 126 to combine the one or more advertisements with the media content from the persona to produce a file that can be stored. At the appointed time, workflow engine 124 uses API module 128 to access a suitable application for sending the file to the user in a phone call, in a multimedia message, or as a link within a message (as previously discussed).

In a particular example, the advertisement selection rules may include verifying that a selected advertisement has not been played for the particular subscriber for at least two previous advertising plays. Further, the advertisement selection rules include demographic rules setup by the client that specify the demographics of the audience for which the advertisement is intended. Additionally, the advertisement selection rules may include demographic settings defining a desired demographic to which the advertisement is targeted. In still another example, the advertisement selection rules include rate, budget and other data that establish a frequency of selection as well as a likelihood that a particular advertisement will be selected. For example, an advertisement that has a rate of $0.20 per play is more likely to be selected than one that has a rate of $0.05 per play, at least until the associated budget is depleted.

In another example, subscriber module 120 operates in conjunction with GUI generator 140 to provide an interface to the subscriber that allows the subscriber to upload media content and to schedule or otherwise send a audio message including the media content to one or more other subscribers. Additionally, the user may respond to a broadcast message from a persona, for example, by pressing a button or link in response to the broadcast message and by uploading media content. Thus, server system 102 can also operate as a multimedia social network to allow subscribers to interact with one another and with one or more personalities and to allow subscribers to schedule receipt of content from one or more personas.

It should be understood that each user (subscriber, celebrity, etc.) can establish one or more personas within system 100. For example, a user may create a work persona and a personal persona, which serve as digital representations of the user within the system. An actor may establish multiple personas, one for each character of interest, so that the user may subscribe to multiple personas, including his/her favorite character.

In a particular example, a user can schedule a meeting reminder by accessing a website provided by server system 102, logging into the subscriber's account and entering data specific to the meeting. Further, the user can configure the reminder to be provided by a particular personality, such as a fictional radio personality named “Buddy the Man.” In response to saving the meeting reminder in schedule data 142, workflow engine 124 causes client module 130 to prompt the personality “Buddy the Man” to record a short reminder alert as an audio clip, a video clip, a text alert, or in whatever format is specified for the particular subscriber. Once the user associated with the personality “Buddy the Man” logs into the system and records or uploads the media content, the media content is stored in memory 118 and the queues 134 are updated. Workflow engine 124 then operates in conjunction with the advertisement selection logic 136 to produce a file or media content packet including the media content from the personality and the advertisements.

When the user receives an alert, the alert may include an option for the subscriber to take advantage of a special offer or to reply (such as to an email, audio response, video response, or any combination thereof) in order to post a response on a social media website. Selection of the option may cause the user's device to link to a page to assist the user in creating and/or uploading a response and publishing the response so that others may access it. In one embodiment, selection of the option may trigger the user's device to prompt the user through a process of creating and/or uploading a response. Such reply data may be stored in subscriber data 122 and posted to a social media site, such as Facebook® or some other website. In one example, audio recordings sent in reply to a cell phone alert, may be recorded in an audio format suitable for posting on a website, such as a website of a radio station associated with the personality to which the subscriber is responding. In another example, the user may post a video recording in response to an alert.

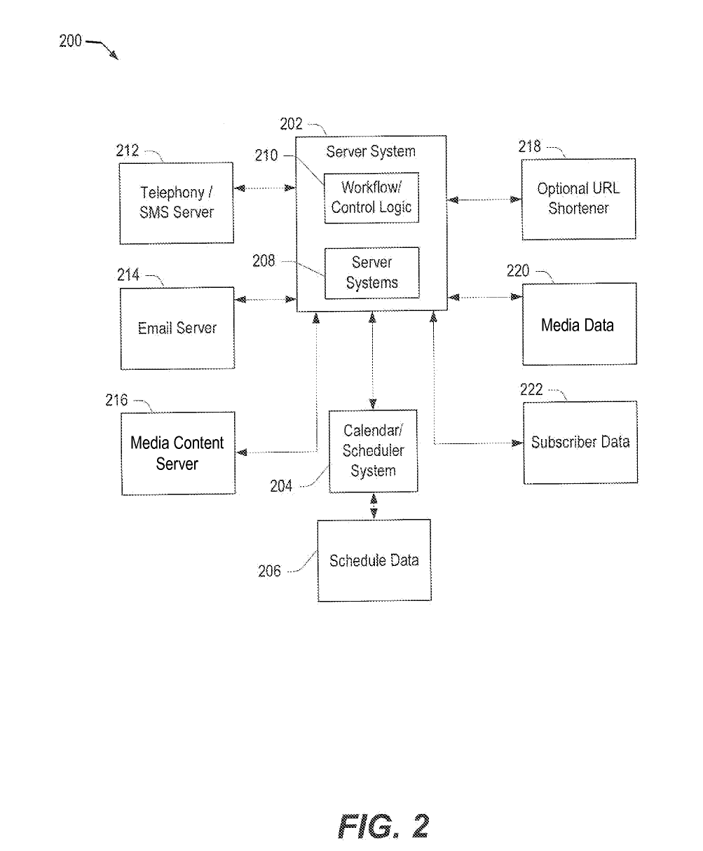

While the above-example depicts a particular embodiment of a server system configured to provide audio alerts, other implementations are also possible. In an example, the above-described server system can be implemented in the “cloud” using what is currently referred to as “cloud computing” by providing software logic to facilitate operation of multiple software applications available within the cloud. An example of such an implementation is described below with respect to FIG. 2.

FIG. 2 is a conceptual block diagram of a system 200 including a server system 202 for providing audio alerts using a plurality of distributed systems and data sources. Server system 202 may include some or all of the elements described with respect to server system 102 in FIG. 1 and may also be coupled to network 104; however, in addition to those elements, some of the data may be stored in other servers or data sources and may be retrieved from those other sources through one or more network connections.

Server system 202 includes workflow/control logic 210 and server applications or systems 208, which cooperate to interact with multiple data sources and multiple distributed services. Server system 202 is coupled to telephony/small message service (SMS) sever 212, email server 214, media content server 216, calendar/scheduler system 204, an optional URL shortener 218, media data 220, and subscriber data 222. Calendar/Scheduler system 204 is coupled to schedule data 206.

In an embodiment, server system 202 can be implemented as a Microsoft® Windows® Azure® server, and server systems 208 and workflow/control logic 210 can be implemented within the Azure® server and standard query language (SQL) protocols. Further, telephony/SMS server 212 can be implemented as a TWILIO™ application, and email server 214 can be implemented as an email client that provides subscribe and unsubscribe email functionality. Additionally, URL shortener 218 can be implemented as a Bitly™ application.

In operation, workflow/control logic 210 coordinates operations of server systems 208 to serve web pages and to receive subscriber data 222 from subscribers and client data, including audio data, from clients. Further, workflow/control logic 210 controls operation of calendar/scheduler system 204 to receive schedule data 206 associated with user events and/or client advertising campaigns. Finally, workflow/control logic 210 controls the media server 216 to format media content, such as audio clips and video clips, and to assemble media files from advertising data and the media content, and controls at least one of the telephony/SMS server 212, email server 214, and optional URL shortener 218 to provide the media content to a user device (such as user device 106 in FIG. 1) at an appropriate time (according to calendar/scheduler system 204 and schedule data 206) and in a suitable format as specified by the subscriber preferences stored in subscriber data 222.

In the illustrated example of FIG. 2, the various functions or capabilities may be distributed across multiple computing systems or may be implemented as software instances on a single computing system. Further, in one instance, the assembled media content may be stored as a single file in a database or just in memory and retrieved for transmission to the subscriber's device (e.g., smart phone, computing device, email account, etc.) at a scheduled time. Alternatively, the media content may be stored and the assembled media content may be stored as a series of pointers into the media data 220 so that the media content can be assembled and transmitted as needed.

In an embodiment, system 200 may capture media content from other data sources, such as news feeds, various social network sites, and so on (based on user preferences from subscriber data 222), and may provide the information to the user according to the user's predefined schedule (according to schedule data 206 and calendar/scheduler system 204). In an example, the user may schedule a morning alert (every weekday morning) to be provided by his favorite celebrity and specify selected content sources. Each day at the scheduled time, server system 202 assembles the media content from media data 220 together with a personalized alert or “lead-in” and optionally a closing from the selected celebrity and sends the alert including the media content to the user's device at the scheduled time. The user may optionally respond to the alert by selecting one or more options presented in the media content, the lead-in, or the closing, and post a response to a social networking site. The response may include audio content, video content, text, or any combination thereof.

In an embodiment, the user may download an application or plugin to his/her computing device, such as a smart phone or portable computer. Once downloaded, server system 202 may deliver the media content to the downloaded application or plugin for presentation to the user. In some embodiments, the application or plugin may periodically interact with server system 202 to retrieve the media content.

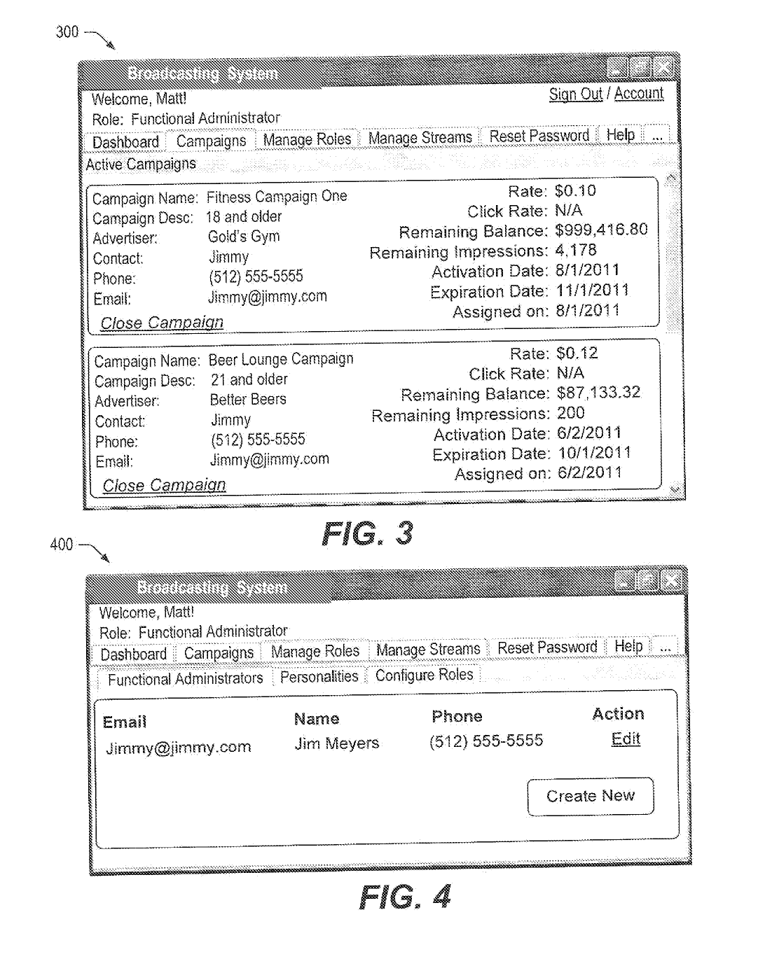

While the above-discussion of FIGS. 1 and 2 introduced two possible systems for implementing a system for providing alerts, FIGS. 3-7 below depict examples of GUIs for capturing advertising data from a client, which data can be combined with media content to provide a customized alert including sponsor information.

FIG. 3 depicts one possible embodiment of a “Campaigns” tab of a GUI 300 for a Broadcasting System of the server system 102 of FIG. 1 or server system 202 of FIG. 2. GUI 300 includes a “Dashboard” tab accessible by a user to access statistics about one or more advertising campaigns, a “Campaigns” tab accessible by a user to view information about the one or more advertising campaigns, a “Manage Roles” tab accessible by a user to manage access to the campaign data, a “Manage Streams” tab accessible by a user to manage media content and/or advertisements, a “Reset Password” tab, and a “Help” tab. GUI 400 may also include other tabs, depending on the implementation.

In this example, a client having a role of “Functional Administrator” is logged into the system and is accessing a “Campaigns” tab within GUI 300. Upon selection of the “Campaigns” tab, a listing of active campaigns is shown including a name of the campaign, an optional text description, the name of the advertiser, the contact, the contact's phone number and/or email address and optionally other information about the client. Further, the “Campaigns” tab includes data about the advertising campaign itself, including a rate per play, a click rate (if applicable), a remaining balance for the campaign, a remaining number of plays (if the number of plays is specified), an activation date, an expiration date, and an assignment date. In some instances, the campaign may be assigned at a first date and scheduled for activation at a later time.

In this example, “Jimmy” is listed as a contact and multiple advertising campaigns are shown. The user may scroll down to access a button for creating a new campaign or for editing an existing campaign. A client may have any number of active or pending campaigns.

In FIGS. 4-7, the “Dashboard,” “Campaigns,” “Manage Roles,” “Manage Streams,” “Reset Password,” and “Help” tabs are again depicted, but are only described with reference to their selection. In FIG. 4, for example, the “Manage Roles” tab is selected, which provides access to a “Functional Administrators” sub-tab, a “Personalities” sub-tab, and a “Configure Roles” sub-tab. The “Functional Administrators” sub-tab is described below with respect to FIG. 4.

FIG. 4 is an exemplary diagram of one possible embodiment of a “Functional Administrators” tab of a GUI 400 for a Broadcasting System of the server system 102 of FIG. 1 or of the server system 202 of FIG. 2. A functional administrator is a user whose role allows him/her to create other users associated with the account, to manage account access, to configure advertising campaigns, and so on. Other roles may provide read only access or otherwise limited access to other users.

In this example, the GUI 400 provides a listing of only one functional administrator Jimmy@jimmy.com and includes a user-selectable “Create New” button for creating a new functional administrator and an “Edit” link for editing and existing functional administrator. Further, the user may interact with the “Create New” button to create a new user and to assign a different role to the user and to edit various parameters for the new user.

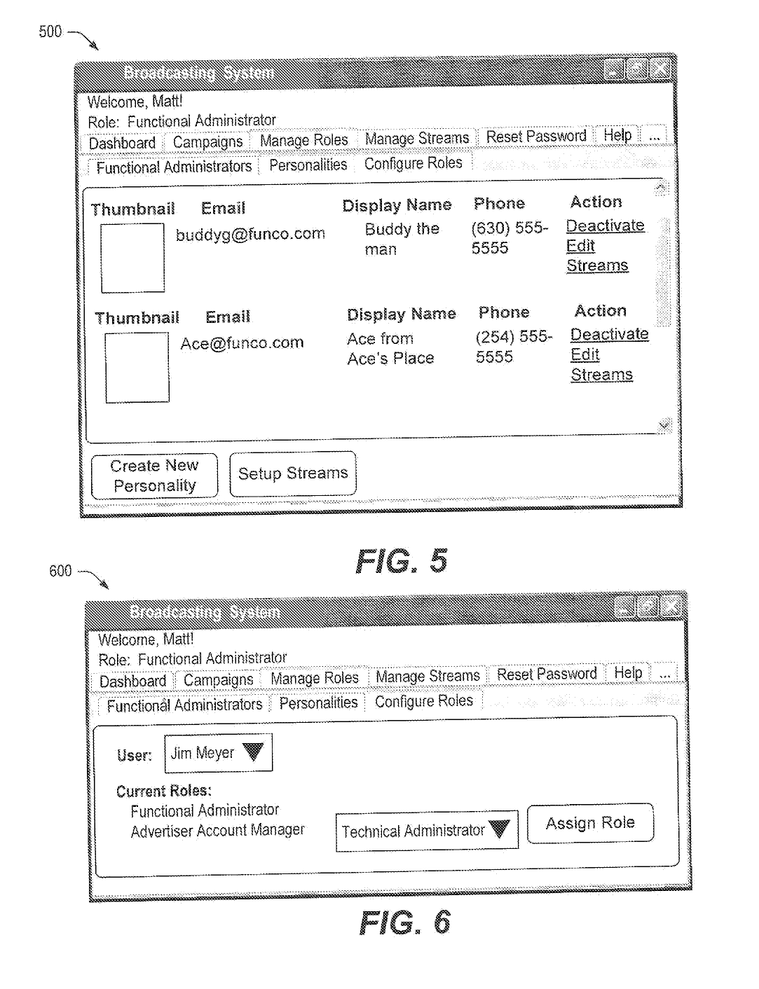

FIG. 5 is an exemplary diagram of one possible embodiment of a “Personalities” tab of a GUI 500 for a Broadcasting System of the server system of FIG. 1. In GUI 500, the “Manage Roles” tab is selected and the “Personalities” sub-tab is also selected. Within GUI 500, thumbnail pictures and contact information is shown for each individual personality. Further, the email or other contact information may be selectable to initiate communication, e.g., by opening an email window for generation of a message to the individual, such as Buddy the Man or Ace from Ace's Place. For a celebrity that has multiple “personalities”, the same celebrity may have multiple instances here, where each “personality” represents a different “character” played by that celebrity.

From the “Personalities” sub-tab, the functional manager can edit a personality, deactivate a personality, or access/edit streams recorded by that personality. The access/edit streams functionality may also be made available to the person or personality to edit his/her own streams. For example, the personality may login to his/her account to see a list of prompts for recording specific audio clips such as a scripted advertisement, for example, or for uploading media content, such as a recorded video, text, audio, or any combination thereof.

FIG. 6 is an exemplary diagram of one possible embodiment of a “Configure Roles” tab of a GUI 600 for a Broadcasting System of the server system of FIG. 1. In GUI 600, the “Manage Roles” tab is selected and the “Configure Roles” sub-tab is also selected. In this instance, the functional manager can select a particular user and assign one or more roles to that user. Each role represents a set of access rights that allow the particular user to access various functions and features of the system. In this instance, GUI 600 includes a pull down menu in which user “Jim Meyer” is selected. GUI 600 includes a listing of the user's current roles including “Functional Administrator” and “Advertising Account Manager”. Further, in GUI 600, a second pull-down menu is provided that allows the user to select other roles, such as “Technical Administrator”. GUI 600 also includes an “Assign Role” button accessible by a user to assign the selected roles to the selected user.

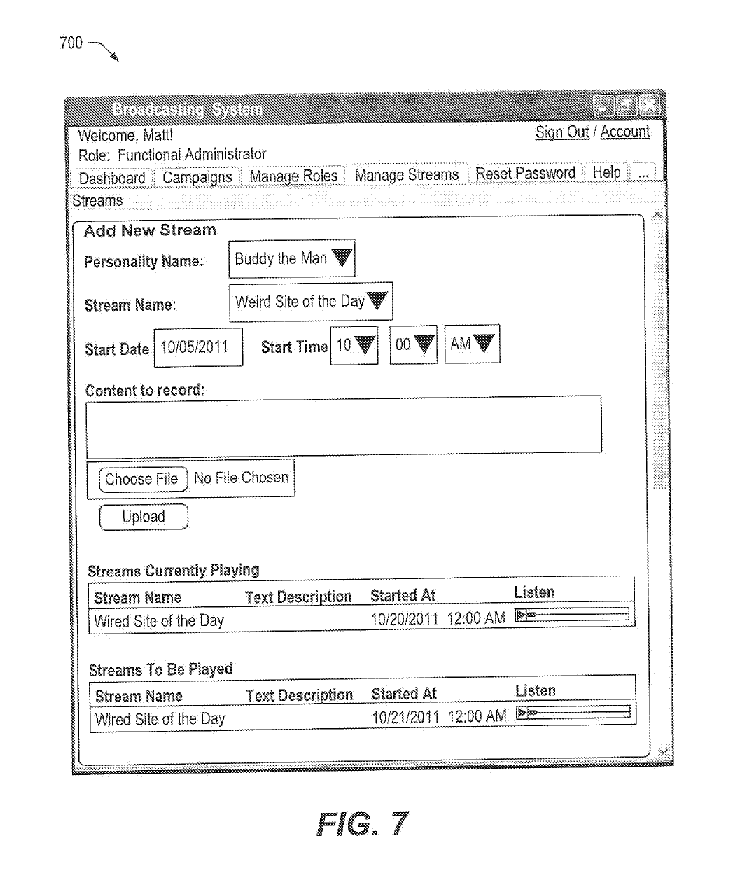

FIG. 7 is an exemplary diagram of one possible embodiment of a “Manage Streams” tab of a GUI 700 for a Broadcasting System of the server system of FIG. 1. In GUI 700, the “Manage Streams” tab is selected. GUI 700 displays a listing of streams to be played, which are recorded audio clips that are scheduled for play at some future date and a listing of streams that are currently playing. In this instance, the streams may be daily audio clips; however, in other examples, the streams may be media content streams that include video, text, audio, or any combination thereof. Further, for a larger add campaign, multiple media content files may be listed as currently playing that have different start and end dates. Further, GUI 700 includes user selectable options for writing text as content to be recorded, for choosing an existing media content file, and/or for uploading an media content. In an example where the user writes text, the user may select a personality for recording the media content based on the text.

In this example, a manager of the radio personality “Buddy the Man” can enter the text for recording by Buddy, including for example a subscriber's name so that Buddy the Man can record a personalized greeting. Alternatively, the manager can upload prerecorded media content by pressing the “Choose File” button and then the “Upload” button. In general, the exemplary GUIs 300-700 in FIGS. 3-7 are provided for illustrative purposes only and are not intended to be limiting. The GUIs may include other buttons and user selectable elements, depending on the implementation.

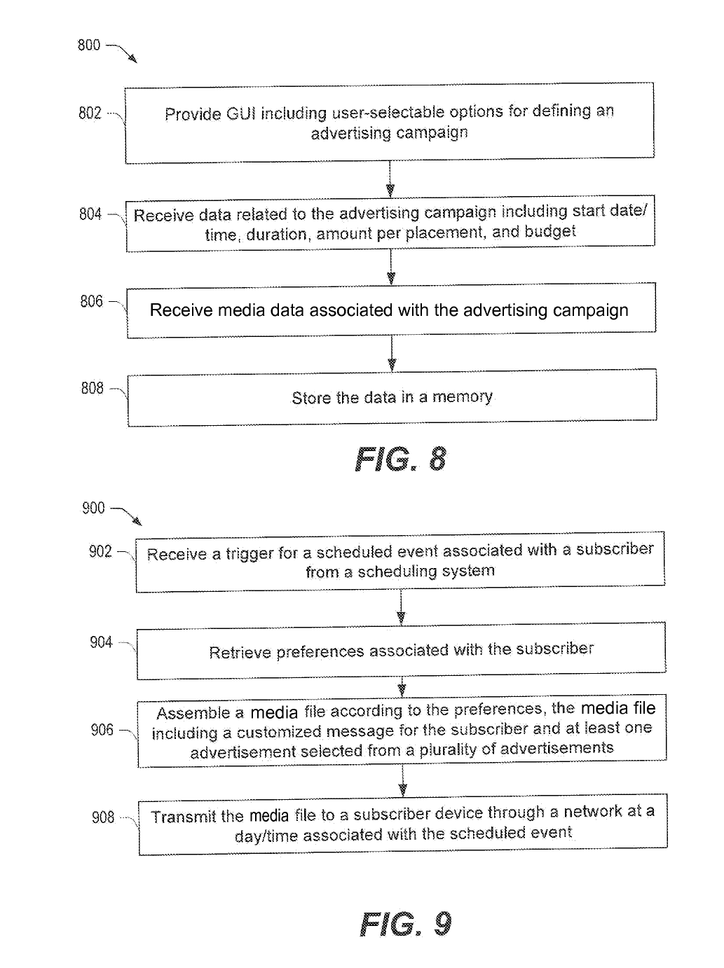

FIG. 8 is a flow diagram of an embodiment of a method 800 of receiving data related to an advertising campaign for inclusion within an alert. At 802, the server system 102 in FIG. 1 or system 202 in FIG. 2 provides a GUI including user-selectable options for defining an advertising campaign. Advancing to 804, the server system receives data related to the advertising campaign, including start date, start time, duration, amount per placement, and budget information. Continuing to 806, the server system receives media data associated with the advertising campaign. Moving to 808, the data is stored in a memory.

It should be understood that the steps depicted in method 800 are exemplary only, and can be performed in a different order. For example, the actions described in blocks 804 and 806 of method 800 may be combined. Further, it should be appreciated that the media data may include audio data, video data, text, or any combination thereof.

FIG. 9 is a flow diagram of an embodiment of a method 900 of providing alerts to a subscriber device according to a user defined schedule. At 902, a trigger for a scheduled event that is associated with a subscriber is received from a scheduling system. In an example, the trigger may be generated by a workflow engine, such as workflow engine 124 in FIG. 1 based on scheduling data stored in a memory. Advancing to 904, the system retrieves preferences associated with the subscriber. Continuing to 906, the system assembles a media file according to the preferences, where the media file includes a customized message for the subscriber and at least one advertisement selected from a plurality of advertisements. In one instance, the media file is assembled in advance of a triggering event and subsequently retrieved from memory. In another instance, the media file is assembled on the fly as needed. Moving to 908, the media file is transmitted to a subscriber device (e.g., a cell phone, a computer, or another device) through a network at a day/time associated with the scheduled event.

In an example, the media file can be a customized or personalized audio alert, recorded for the subscriber by a personality of the subscriber's choice. In an example, the subscriber may enter an event into the calendar and specify a personality for providing the alert corresponding to the event. In such an instance, the system may prompt the personality to record personalized alert, including media content corresponding to the scheduled event, which is stored and then provided to the subscriber's device at the scheduled date/time together with a selected advertisement.

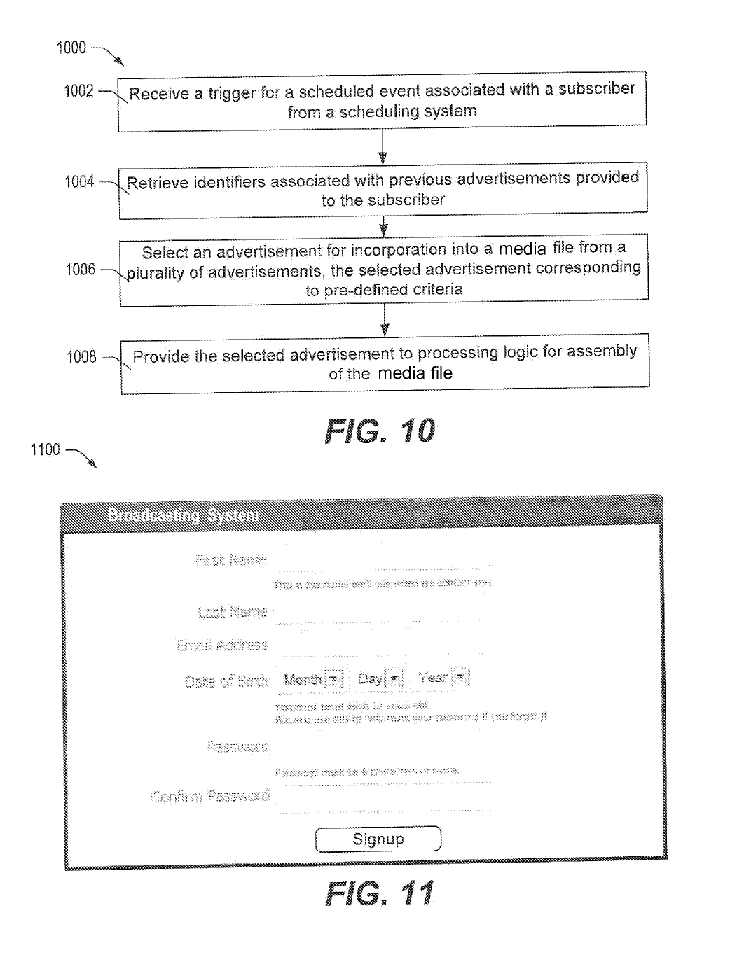

FIG. 10 is a flow diagram of an embodiment of a method 1000 of selecting an advertisement for inclusion within an alert. At 1002, a trigger is received from a scheduling system for a scheduled event associated with a subscriber. Advancing to 1004, identifiers associated with previous advertisements provided to the subscriber are retrieved. Continuing to 1006, the system selects an advertisement from a plurality of advertisements for incorporation into media content, where the selected advertisement corresponds to pre-defined criteria. Such pre-defined criteria can include specified demographic information as well as price per placement, overall budget, and other data.

In one embodiment, the system does not allow an advertisement to be replayed to a subscriber before a number of intervening advertisements are played for the subscriber. For example, in an embodiment, at least two intervening advertisements must be played for the subscriber before a selected advertisement may be replayed for the subscriber.

FIG. 11 is an exemplary diagram of one possible embodiment of a GUI 1100 for creating a new subscriber account. GUI 1100 includes user-selectable elements such as text inputs, email address, date of birth, and password information. GUI 1100 may also include tabs (not shown) that allow the user to configure other parameters or settings, such as a selected stream and desired method of receiving a particular stream. For example, the particular stream may be a multicast message from the subscriber's favorite celebrity that he/she wishes to receive as a video message sent to his/her smart phone. One possible example is described below with respect to FIG. 12.

FIG. 12 is an exemplary diagram of one possible embodiment of a GUI 1200 for allowing a subscriber to subscribe to one or more media content streams GUI 1200 includes a list of streams for a particular radio station, such as ESPN 1440, and a plurality of user selectable options. For example, the subscriber may select between the delivery types (voice, text, video, or email), select one or more streams, and specify days and times for delivery. Once the selections are made, the subscriber selects the “Create Subscription” button to save the user's settings. In another example, the GUI may include a list of streams for a particular celebrity, and the selection options may differ. In one embodiment, the selection options may include voice, text, email and video.

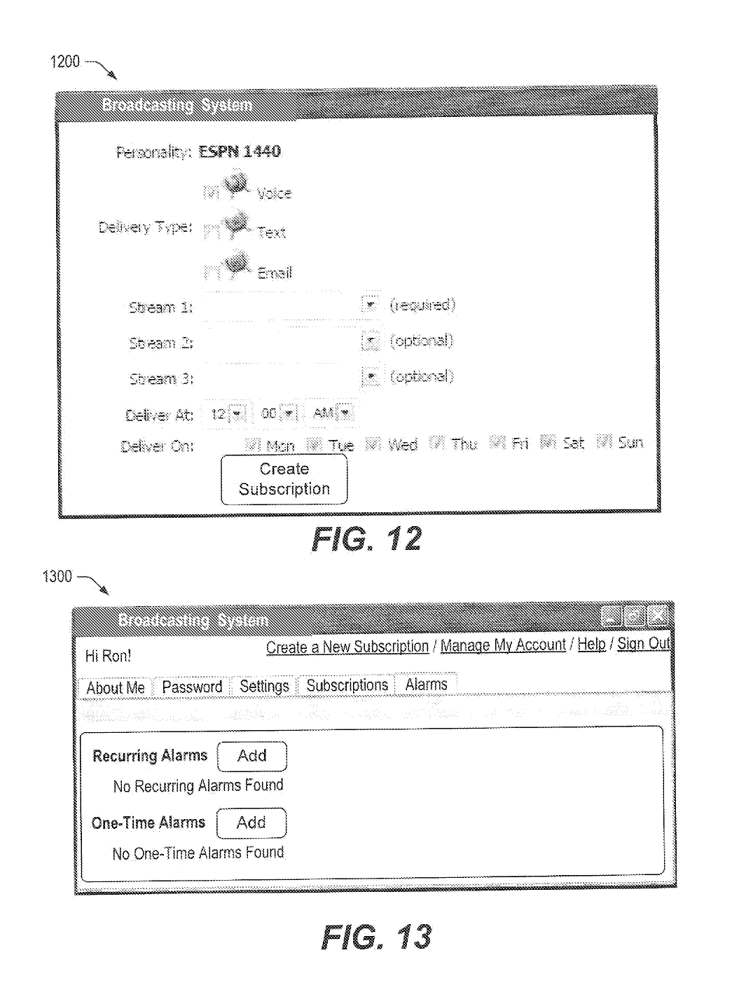

FIG. 13 is an exemplary diagram of one possible embodiment of a GUI 1300 for allowing the subscriber to add and/or configure one-time and recurring alarms. In this instance, GUI 1300 includes an “About Me” tab, a “Password” tab, a “Settings” tab, a “Subscriptions” tab, and an “Alarms” tab. Accessing the “About Me” tab provides access to options for the subscriber to enter data, and accessing the “Password” tab provides access to a user-option to change the password information. Further, the “Settings” tab allows the user to configure subscriber settings, such as preferred delivery methods, etc. Additionally, “Subscriptions” tab allows the user to access a GUI for subscribing to media content streams, such as the audio clips depicted within the GUI 1200 depicted in FIG. 12.

In GUI 1300, the “Alarms” tab is selected. GUI 1300 shows a listing of recurring alarms and a user-selectable “Add” button to create a recurring alarm. GUI 1300 also includes a listing of one-time alarms and a user-selectable “Add” button to create a one-time alarm. In an example, when the subscriber selects the “Add” one-time alarm button, the GUI provides an option for selecting date and time information and optionally for specifying a personality to customize the alert.

In general, the systems, methods, and interfaces described above provide a social media system to facilitate communications between subscribers and personas. The system includes a scheduling system that allows the user to schedule receipt of particular alerts, to specify the form and format of the alert, and to select a persona for providing customized media content that is used to form at least a portion of the alert, such as a “lead-in”, a closing, or some other portion of the alert that may be personalized to the particular user. In some embodiments, the alert may include a user-selectable option that allows the user to respond to the persona, posting a response (audio, video, text, or any combination thereof) on a social networking site.

In conjunction with the systems, methods and GUIs described above with respect to FIGS. 1-13, a system is disclosed that links advertisers, personas, and subscribers for providing an alert scheduling system that allows a subscriber to subscribe to broadcast audio/text data from particular personas and to schedule alerts. The system provides media content from personas together with selected advertising information that is customized for the user to provide a personalized, scheduled alert for the subscriber and optionally facilitating interactions between the subscriber and the persona by allowing the user to respond.

Although the present invention has been described with reference to preferred embodiments, workers skilled in the art will recognize that changes may be made in form and detail without departing from the scope of the invention.

What is claimed is:

1. A computer-readable storage medium embodying instructions that, when executed by a processor, cause the processor to:
receive media content from one or more sources, the media content including a first portion that is personalized for a user by a selected persona of a plurality of personas;
store the media content in a memory; and
send an electronic alert including the media content to a user device.

2. The computer-readable storage medium of claim 1, further including instructions that, when executed, cause the processor to send the electronic alert to the user device according to a user-defined schedule.

3. The computer-readable storage medium of claim 1, wherein the media content comprises at least one of audio data, video data, text data, and a static image.

4. The computer-readable storage medium of claim 1, wherein the media content comprises a second portion including an advertisement.

5. The computer-readable storage medium of claim 1, wherein the electronic alert is sent to one of an application and a plugin executing on the user device.

6. The computer-readable storage medium of claim 1, further comprising instructions that, when executed, cause the processor to:
receive a first user input configured to schedule the electronic alert, the user input including schedule information including at least one of a date and a time;
receive a second user input configured to select the selected persona from the plurality of personas; and
store the schedule information and an identifier associated with the selected persona in the memory.

7. The computer-readable storage medium of claim 6, further comprising instructions that, when executed, cause the processor to:
notify the selected persona; and
provide an option for the selected persona to provide the portion personalized for the user.

8. The computer-readable storage medium of claim 1, wherein the media content includes a user-selectable option accessible by the user to transmit an electronic response to the media content.

9. The computer-readable storage medium of claim 8, wherein the user-selectable option includes at least one of a clickable link within an electronic message and a numeric operation for selection from a keypad in response to an audio alert.

10. The computer-readable storage medium of claim 8, further comprising instructions that, when executed, cause the processor to:
receive a response including at least one of audio data, video data, and text data; and
store the response in the memory.

11. A system comprising:
an interface configurable to couple to a network;
a processor coupled to the interface; and
a memory accessible to the processor, the memory configured to store instructions that, when executed by the processor, cause the processor to:
assemble media content including a first portion customized for a subscriber by a selected persona of a plurality of personas;
determine a scheduled event associated with the subscriber; and
transmit the media content through the network to a device associated with the subscriber according to the scheduled event.

12. The system of claim 11, wherein the media content comprises at least one of audio data, video data, and text data.

13. The system of claim 11, wherein the first portion is customized to the scheduled event.

14. The system of claim 11, further comprising:
a schedule database configured to store an electronic calendar associated with the subscriber; and
a graphical user interface (GUI) generator including a user-accessible calendar configured to allow the subscriber to define the scheduled event.

15. The system of claim 14, wherein the scheduled event comprises a date and time scheduled by the subscriber and the media content is transmitted at the date and time.

16. The system of claim 11, wherein the media content includes a user-selectable option accessible by the subscriber to provide a response to the media content.

17. The system of claim 11, wherein the memory further comprises:
instructions that, when executed, cause the processor to receive the response and to store the response in a memory; and
wherein the response includes at least one of audio data, video data, and text data.

18. The system of claim 11, wherein the memory further comprises advertising selection logic that, when executed, causes the processor to:
select an advertisement from a plurality of advertisements according to demographic information associated with the subscriber, data associated with the advertisement, and playback data associated with advertisements previously provided to the subscriber; and
wherein the media content includes the advertisement.

19. A method comprising:
receiving a first media content customized for a subscriber by a selected persona of a plurality of personas;
selecting an advertisement from a plurality of advertisements according to a plurality of selection rules;
combining the first media and the advertisement to produce media content; and
transmitting the media content to a subscriber device through a network according to a predetermined schedule.

20. The method of claim 19, further comprising:
receiving a first user input to schedule one or more alerts, each alert having a date and time, the one or more alerts defining the predetermined schedule; and
receiving at least one second user input to select the persona from a plurality of personas; and
wherein the first media content includes a first portion customized for the subscriber by the selected persona.

21. The method of claim 20, wherein receiving the first media content comprises:
sending an alert to the selected persona to prompt the selected persona to provide media content; and
receiving the first media content in response to sending the alert.

22. The method of claim 19, wherein the media content includes a user-selectable option accessible by the subscriber to respond to the media content, the method further comprising:
receiving a second media content from the subscriber device in response to transmitting the media content; and
posting the second media content to a social network site.
